(19) United States
(12) Patent Application Publication
(10) Pub. No.: US 2005/0056966 A1
(43) Pub. Date: Mar. 17, 2005

(54) Filtration devices comprising a sealing gasket

(76) Inventors: Andrew Bartlett, Lowell, MA (US); Mark Chisholm, Boston, MA (US)

Correspondence Address: MILLIPORE CORPORATION, 290 CONCORD ROAD, BILLERICA, MA, 01821, US

(21) Appl. No.: 10/700,005

(22) Filed: Nov. 3, 2003

Related U.S. Application Data
(62) Division of application No. 09/937,114, filed on Sep. 20, 2001.
(60) Provisional application No. 60/140,408, filed on Jun. 22, 1999.

(51) Int. Cl. B29C 45/14

(52) U.S. Cl. 264/259; 264/320

(57) ABSTRACT

The present invention relates to the formation of a gasket, sealing area or O-ring, such as a gasket on a screen for a filtration module such as a TFF or NF cassette or an O-ring on the outlet of a filter catridge wherein the seal is proud of at least one surface of the screen. Preferably, the seal is molded to the filter component. more preferably it is injection molded to the component. The seal may be formed of any elastomeric material such as thermoplastic, thermoplastic elastomers, thermosets and rubber, both natural and synthetic. The molded seal provides better sealing, allows for a variation in heights and geometries, and provides better cleanliness and lower extractables than the currently used adhesives or conventional gaskets or O-rings.

The present invention relates to a sealing gasket for filtration devices. More particularly, it relates to the use of an integrally formed seal on or in a filtration device.

### BACKGROUND OF THE INVENTION

The use of filtration devices is well known. Typically, these are used to filter liquids that contain various molecules that are desired to be removed from the liquid. Three basic designs are used. A flat sheet disk-shaped membrane in a holder, a cylindrical (pleated or unpleated or spiral wound) cartridge and a cassette with one or more flat filters.

In the disk membrane format, a membrane is held in a liquid tight arrangement about the periphery between a top and bottom holder plate. The seal is formed by flat surfaces of the holders, a knife edge arrangement on the holder surfaces on one or both sides of the membrane.

In the cartridge format, silicone gaskets, adhesives such as epoxies or urethanes, heat sealing or solvent bonding methods are often used to form the liquid tight seal between the core and the outlet, the ends of the filter element such as the attachment of end caps to one or both ends of a pleated filter, and other places where a liquid tight seal is required.

In cassette formats, the liquids are filtered within a plurality of filter modules that are stacked between manifolds or individually sealed to a manifold plate. Each module contains one or more filter layers separated by appropriate spacers layers such as screens and an impermeable outer layer on each outer surface of the module. At one or both ends of the modules are a series of ports that permit liquid feed to flow into the apparatus as well as filtrate and retentate to flow from the apparatus. It may be run in either a tangential flow (TFF, including HPTFF) manner or in a dead end or normal flow (NF) manner.

In a TFF operation, a fluid is fed from the feed port(s) to the space between the feed screen and filter and flowed across the face of the filter in a direction tangential to the flow of filtrate through the filter.

In a NF operation fluid is flowed directly at the filter surface and that fluid which is capable of passing through the membrane does so and the rest is left on the upstream side of the membrane.

Some modules have been sealed by injection molding complete cassettes into a uniform device, see U.S. Pat. No. 5,824,217. However, to use these modules one needs to acquire new manifold equipment that is an expensive capital investment. Most cassettes use a stacked manifold design held between two liquid impervious holder plates, typically made of stainless steel, The cassette modules typically have the filtrate side sealed from the retentate side of the cassette by adhesives, in particular epoxy or urethane adhesives. In addition to using the adhesive as the sealing means, it is also applied around one or more of the fluid ports, in particular the feed screen port to create a gasket that separates the feed port from the retentate and/or filtrate ports. At the current time, such gaskets are simply the same height as the screen itself and for many applications this has been sufficient. The system relies upon a compression seal to maintain integrity and prevent leakage between the various ports.

However, in some processes this type of seal is not sufficient. For example where the process calls for the use of alternating of hot and cold fluid cycles, it has been found that the seal is often insumcient and tends to leak. Likewise, when using compressible membranes such as reinforced composite cellulosic membranes, especially at higher pressures (>50 psi), the seal fails due to the compression of the membrane by the pressure of the fluid which allows for leakage.

In all three formats, the above methods of providing a seal or gasket have been less then satisfactory.

Adhesives are undesirable since they have limited chemical compatibility, are a source of significant extractable species, introduce process control difficulties, impose bond strength limitations, impose use temperature limitations and increase process cycle time.

Direct heat sealing wherein a heating element contacts a material which flows to form a seal is undesirable since its use imposes a limitation upon the thickness of the material being heat sealed. This results in a material reduction of the number of layers that can be present in a given volume of the filtration device, thereby undesirably reducing the filtration capacity of the device. In addition, direct heat sealing is undesirable because it requires multiple steps, imposes material compatibility limitations and requires a substrate to effect direct heat sealing of filtration elements.

Solvent bonding is undesirable since solvents impose environmental limitations on liquids to be filtered.

In addition, the use of materials such as polysilicone based materials as sealing materials, O-rings or gaskets is undesirable as they absorb a portion of a feed being filtered into their structure and then allow the absorbed material to be desorbed into subsequently filtered samples thereby contaminating them. Additionally, these free standing gaskets often fall out of the device during installation or repair or replacement and often are improperly seated which causes them to leak. Moreover, loose fitting seals such as O-rings create dead space behind the gasket sealing surface (such as between the inner wall of the O-ring and the wall of the filter housing to which it is attached). This dead space is a breeding ground for bacteria, molds, viruses and yeasts, all of which compromise the sterility and integrity of the seal and the filtration device.

What is required is a better material and method for the construction of sealing materials, O-rings and gaskets for all of these devices.

### SUMMARY AND OBJECTS OF THE INVENTION

The present invention relates to the formation of a seal around a filtration element to be sealed, such as one or more fluid ports in a filtration module. The use of thermoplastic materials, especially those that can be molded, preferably injection molded in place are preferred as it forms an integral, sanitary gasket or seal. The claimed materials are low in extractables and absorption/desorption of filtration fluids making them cleaner to use and ensuring that the sealing material does not add or remove any constituent of the fluid being filtered other than that desired by the filter action of the device (such as particulates, bacteria and viruses). Moreover, in the preferred molded in place embodiments, it prevents the seal from moving or be being improperly aligned upon sealing ensuring that the seal is always consistently the same. Lastly, when using it in the preferred molded in place embodiments, the seal has no dead space behind it in which microorganisms might otherwise grow.

In a cassette device, the seal is formed on at least one side and preferably on both sides of the component such as a screen and is proud of or raised above the surface of the component. Preferably, the seal is molded to the component, more preferably it is injection molded to the component. The seal maybe formed of any elastomeric material such as a thermoplastic polymer, copolymer or terpolymer, thermoplastic elastomers, thermosets such as urethane, especially closed cell foamed urethane, and rubber, both natural and synthetic. The molded seal provides better sealing, allows for a variation in heights and geometries, in cassettes the use of more open screens, in some cases the elimination of a screen per se via the use of a molded rim of seal which forms an open space which acts as the screen and provides better cleanliness and lower extractables than the currently used adhesives.

It is an object of the present invention to provide a seal for a filter device comprised of a thermoplastic elastomer.

It is a further object of the present invention to provide a sealing means for a filtration device wherein the sealing means is formed of a thermoplastic elastomer that is molded in place on to the filter device.

It is another object of the present invention to provide a filtration module comprising at least one membrane layer, at least one feed screen layer and at least one filtrate screen, said at least one feed screen layer and said at least one filtrate layer having one or more ports formed in at least one of its edges and said layers being arranged on opposite sides of the membrane to insure fluid flows through a port on the feed screen layer into the feed screen layer, from the feed screen layer through the membrane and into the filtrate layer and through the one or more ports of the filtrate layer to an exit from the module, wherein the one or more ports of at least the feed screen and filtrate layer contain a molded seal which has a thickness greater than that of the screen and said thickness of said seal extends from at least one side of said layer.

It is a further object of the present invention to provide a filtration module comprising two outermost end cap layers which are impermeable to liquids and can be either metal or plastic holders which retain the module in place or plastic films which form the out layers of the module, one or more one screen layers inside of the end caps, one or more filter layers inside the one or more screen layers, wherein at least one screen layer is a feed layer and contains a series of one or more feed stream ports in at least one of its peripheral edges, said feed stream ports being sealed by a molded seal which has a thickness greater than that of the screen and said thickness of said seal extends from at least one side of said screen.

### IN THE DRAWINGS

FIG. 1 shows a cross sectional view of a first embodiment of the present invention.

FIG. 2 shows a cross sectional view of a second embodiment of the present invention.

FIG. 3 shows a planar top view of either the first or second embodiments as shown in FIGS. 1 and 2.

FIG. 4 shows the second embodiment of the present invention in a TFF module in cross sectional view.

FIG. 5 shows another embodiment of the present invention in a TFF module in cross sectional view.

FIG. 6 shows another embodiment of the present invention designed specifically in a normal flow (NF) configuration.

FIG. 7 shows an endcap layer with an injection molded rim which in conjunction with an adjacent layer forms an open volume or space which acts as a screen according to the teachings of the present invention.

FIG. 8 the use of gaskets according to the present invention in conjunction with connecting a filter device to the manifold plates of a cassette format.

FIG. 9 shows a cartridge in which the silicone O-rings are replaced by the thermoplastic elastomer O-rings of the present invention.

FIG. 10 shows a graph of the test results of Example 1.

### DETAILED DESCRIPTION OF THE INVENTION

The present invention relates to a sealing device such as a potting of a membrane, a seal edge on a membrane or a screen or a support layer surrounding the membrane or other component of a filter device, a gasket on a membrane port or outer edge or a screen port, an O-ring and other similar sealing components typically used in the manufacture of filtration devices.

The present invention uses selected materials for the sealing devices which have an ease of formation and application, low extractables, low absorption/desorption of components from the fluid being filtered. These materials include but are not limited to any elastomeric material such as a thermoplastic polymer, copolymer or terpolymer, thermoplastic elastomers, thermosets such as urethanes, especially closed cell foamed urethane, and rubber, both natural and synthetic.

In a preferred embodiment, the sealing device is injection or insert molded or otherwise integrally formed (by bonding, etc) to a component of the device, especially a plastic or other comparable material (glass mesh, woven fabric, etc.) to which the seal can bond and be retained. In this way, one obtains an integral seal on the device which has several advantages in the ease of assembly and use, the assurance that the seal is always retained at the right location and cannot be mis-aligned or mis-sealed. Additionally, in these molded in place embodiments, the seal eliminates any dead space between the seal and the filter component to which it is bonded in which a microorganism such as a bacteria, yeast, mold or virus could otherwise grow and threaten the integrity and sanitary condition of the filter.

The present invention will now be explained in relation to several of the preferred embodiments, in particular in relation to an embodiment of the invention used on screens of a cassette type filtration device. However, through these illustrations, it is not meant to limit the invention to those particular embodiments.

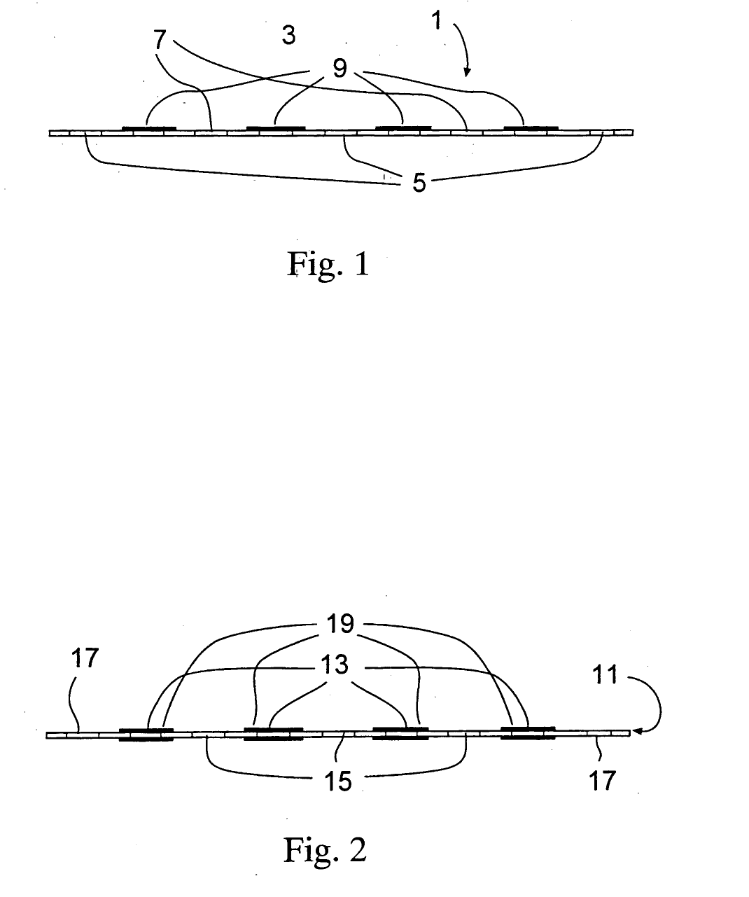

FIG. 1 shows a first embodiment of the present invention. It shows a feedscreen for a cassette filtration device. The feedscreen 1 has a series of ports 3, 5 and 7 which correspond to the feed, retentate and filtrate ports of the filtration device. As shown, the ports 3 have a gasket 9 formed around them to isolate them from the other ports. In this embodiment, the ports 3 are the filtrate ports of the feed screen so as to keep feed fluid separate from the filtrate. As shown, the gaskets 9 are formed through the screen and are proud or raised above the surface of the screen on one side only.

FIG. 2 shows a second embodiment of the present invention. The feedscreen 11 has a series of ports 13,15 and 17 that correspond to the feed, retentate and filtrate ports of the device. As shown, the ports 13 have a gasket 19 formed around them to isolate them from the other ports. As shown it is formed through the screen and is proud or raised above both major surfaces of the screen.

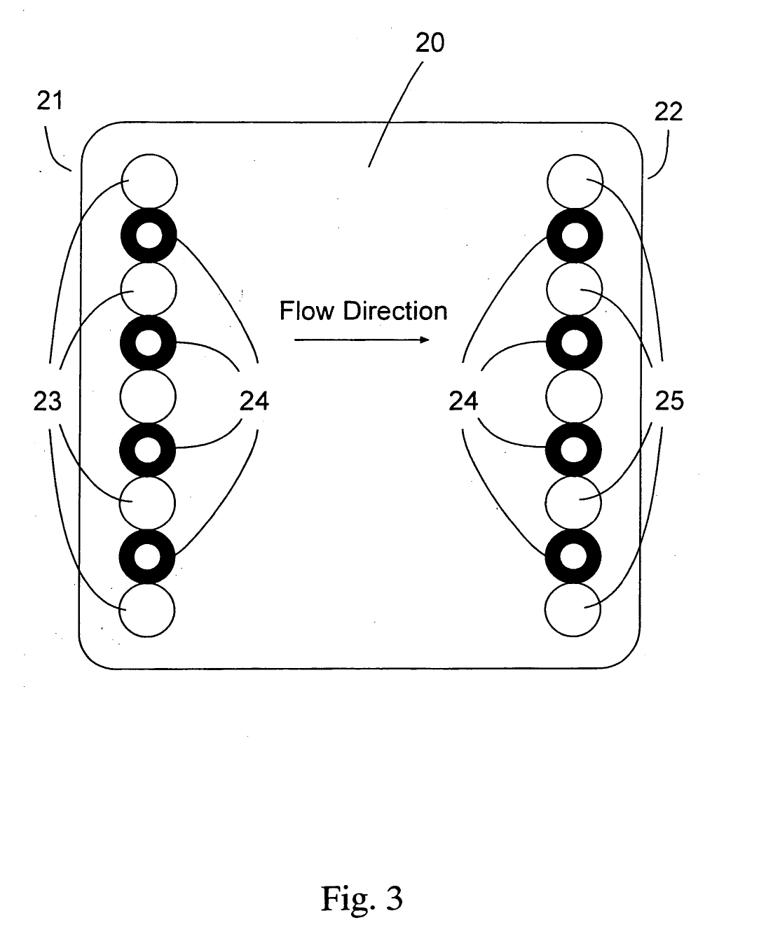

FIG. 3 shows a planar top down view of either embodiment of FIGS. 1 or 2. As shown, a feed screen 20 has a feed side 21 and a retentate side 22. Fluid flows across the screen from the feed side 21 to the retentate side 22. There are five ungasketed feed ports 23 and four gasketed filtrate ports 24 on the feed side 21. Likewise there are four gasketed filtrate ports 24 and five ungasketed retentate ports 25 on the retentate side 22 of the screen 20. The gaskets surround and isolate the selected ports 24 from the other ports 23,25. For a filtrate screen, the gaskets would be formed around the feed and retentate ports and the filtrate ports would left ungasketed.

While shown as a circular design, it is understood that the gasket merely needs to surround the fluid port and may be of any geometric design such as irregular, circular, oval, ellipsoid, triangular or polygonal (square, rectangular, pentagonal, hexagonal, octagonal, decagonal, etc). The design selected is at the discretion of the designer so long as it doesn't interfere with any function of the device.

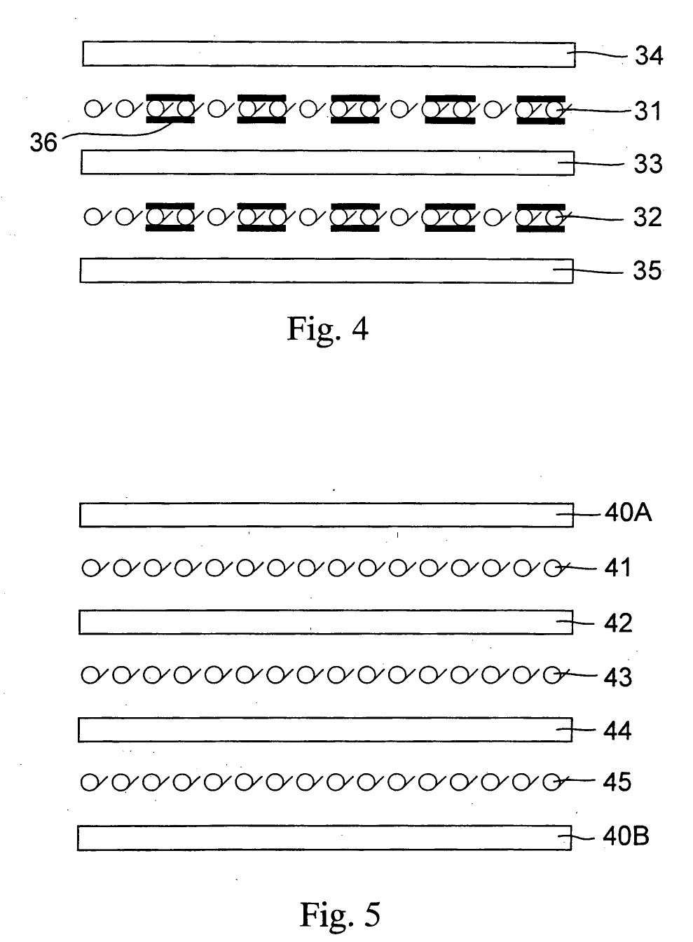

FIG. 4 shows a cross section of a filtration module according to the present invention in its simpler form. A feed screen 31 and a filtrate screen 32 are positioned on opposite sides of a membrane 33. A first and second endcap layer 34 and 35 are located adjacent to and outside of the screens 31 and 32 to complete the package. The endcaps 34 and 35 may be the endplates of the filtration device such as stainless steel or plastic plates or separate layers formed as part of the module as described in U.S. Pat. No. 5,824,217 the teachings of which are herein incorporated by reference in its entirety. As shown, the gaskets 36 maintain the seal between the feed screen 31 and the gasket 36 and filtrate screen 32 and gasket 36 respectively for the desired ports. In this embodiment, fluid flows into the feed screen 31 through one or more non-gasketed ports formed in the screen 31 and which are connected to a source of fluid to be filtered. A portion of the fluid passes through the membrane 33 and the filtrate is removed from the module from one or more ports formed in the filtrate screen 32.

FIG. 5 shows a cross section of a TFF module according to the present invention in a preferred form. The outer portions of the module are comprised of a first and second endcap layers 40 A and B. A first feed screen 41 is position inward of and adjacent to the endcap layer 40A. A first membrane layer 42 is position inward of and adjacent to the first feedscreen 41.Inward of that is a filtrate screen 43. Below that is a second membrane layer 44 followed by a second feedscreen 45 and the other endcap 40B which forms the other outer end of the module. Fluid flows from the feed screens 41 and 45 through one or more feed ports and through the membranes 42 and 44 to the filtrate screen 43. From there, the fluid is removed for further processing.

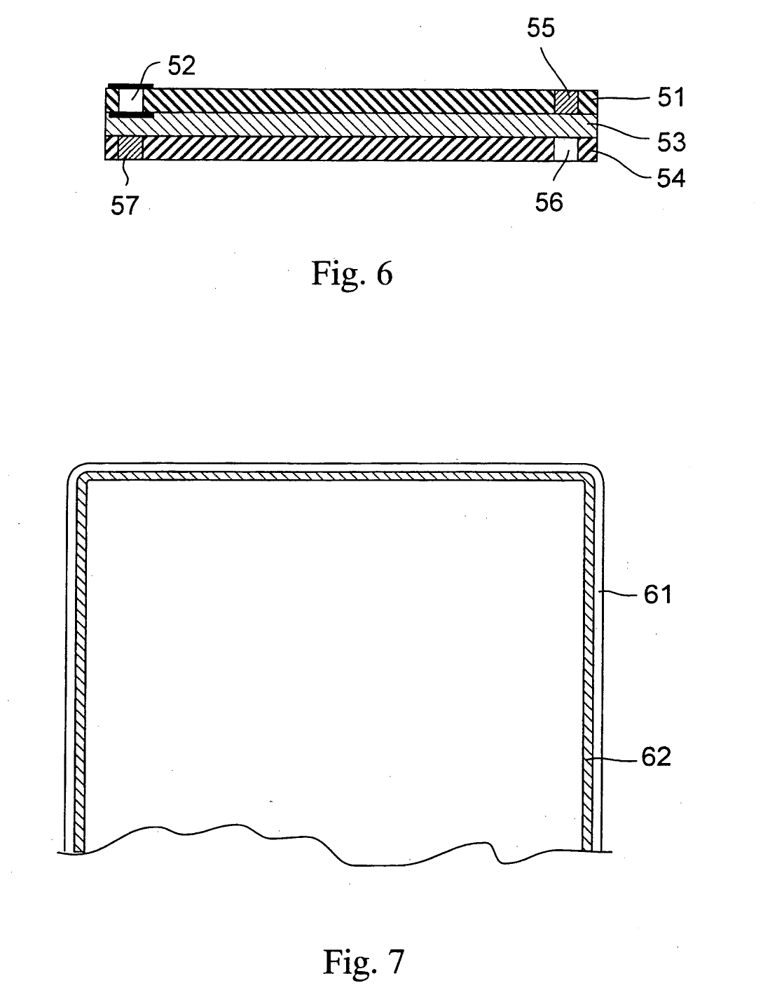

FIG. 6 shows a NF or normal flow module. In this module, a feed screen 51 has one or more ports 52 located on one end of the screen. Fluid enters through these ports and a portion passes through the membrane 53 and is collected in the filtrate screen 54. The fluid which does not pass through the membrane remains upstream of the membrane as the retentate port 55 as shown has been sealed so as to prevent any tangential flow. The filtrate exits the device through one or more filtrate ports 56 formed on the end of the filtrate screen 54 opposite of the open port(s) 52 of the feed screen 51. The one or more filtrate ports 56 below the open feed ports 52 have been also been sealed to prevent any channeling or tangential flow from occuring.

If desired, other arrangements may be made, such as using a central feedscreen and outer permeate and/or filtrate screens, additional filter layers, etc. Numerous variations can be made to combine the membranes and spacer (feed and retentate screen) layers to form workable devices. Additionally, the screens and modules of the present invention may as discussed above be used in tangential flow filtration devices or in dead end or normal flow filtration devices. See U.S. Pat. No. 5,824,217 for such variations, the teachings of which are herein incorporated by reference in its entirety.

The screen be it a feed screen, filtrate screen or retentate screen may basically be a defined open volume or a porous single layer such as a screen per se.

One such open volume screen can be formed by one or more sealing rims or outer edge gaskets formed on a surface of an adjacent layer such as a membrane or endcap and thereby defines a volume of space between two adjacent layers such as an endcap layer and a membrane. This acts in the same manner as a screen and is therefore for the purposes of the invention considered to be a screen. In this embodiment, it is preferred that the rim or rims be formed of the same material and formed in the same way as the gaskets and have the same height dimensions as the gaskets to ensure that a complete seal is formed between the various layers. More particularly, the rim or rims are formed by injection molding.

FIG. 7 shows an endcap 61, such as is made of a a nonporous polyethylene sheet on which a rim 62 has been injection molded to form such a space when assembled next to another layer such as a membrane.

In addition to be used as a seal around a port or as a rim or rims to form a open space screen, one may also form various structures on or in the surfaces of the various layers to control flow distribution, residence time or other factors of the device or the fluid within the device.

While the invention has been largely explained in reference to a first preferred embodiment relating to the screens of a cassette type filtration device, its use is not so limited.

For example, it may be used with traditional filter holders which comprise two rings capable of being clamped together and holding a membrane between the two rings in a liquid tight sealing arrangement. The use of the thermoplastic elastomers as seals in that device is quite helpful in forming a liquid tight seal. If desired, the sealing surface of one or both holders may have a groove, such as a dovetail or other undercut arrangement formed in its surface and the thermoplastic elastomer may be molded into the groove and made proud of that groove and surface so as to form a sealing device for the holder.

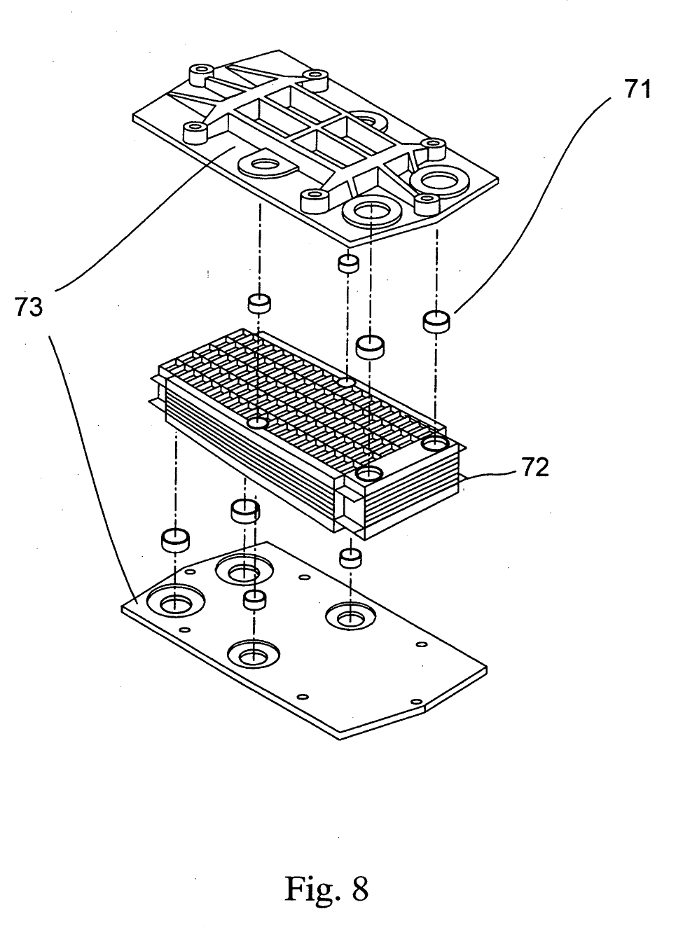

The invention may also be used to form gaskets 71 used to connect the filter device 72 to the manifold plate 73 as shown in FIG. 8. These gaskets may be preformed or formed in place as desired. Preferably, they are formed in place so as to ensure that they do not dislodge from the device during assembly or become mis-aligned during assembly and thereby mis-sealed. If the seal is formed on a structure which is reused, it is preferred that the bond to the component be sufficient to ensure that the seal stays in place during normal use and handling, but is capable of being removed and replaced as is needed over time.

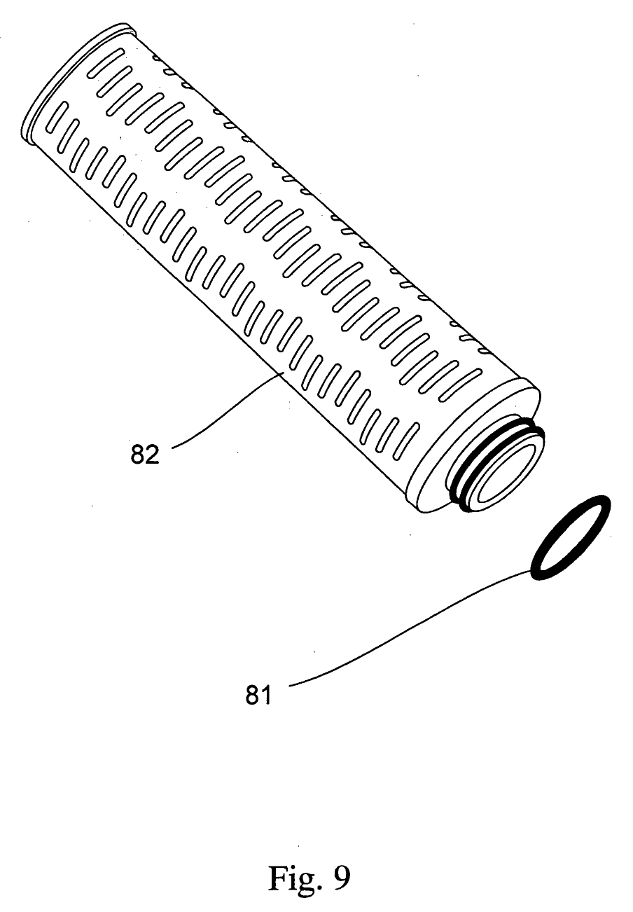

Altematively, the invention may be used as shown in FIG. 9 to form O-ring seals 81 used on cartridge filter devices 82 in lieu of the traditional silicone or PTFE resin O-rings. As discussed above they may be preformed or formed in place. The current cartridge housing design typically has a slight recess formed around the circumference of the device where it retains the O-ring. The O-ring of the present invention may be molded to that recess directly or if desired that recess can be modified to have an undercut or retention feature such as a dovetail to ensure that the O-ring is formed in-place and will stay in-place.

The screen, if used, may alternatively be a woven, nonwoven or porous structure such a as a woven polyethylene, polypropylene, fiberglass, glass, carbon or polyester screen, a nonwoven screen such as spun bonded fabric or TYVEK® or TYPAR® paper. It may also be in the form of a scrim or as a porous film such as a highly porous membrane. Alternatively, it may be made from a film in which a series of holes, channels or openings are formed or it may be made of a cast grid like structure.

The membrane may be a microporous, ultrafiltration (UF), nanofiltration or reverse osmosis membrane formed of a polymer selected from olefins such as polyethylene including ultrahigh Molecular weight polyethylene, polypropylene, EVA copolymers and alpha olefins, metallocene olefinic polymers, PFA, MFA, PTFE, polycarbonate, vinyl copolymers such as PVC, polyamides such as nylon, polyesters, cellulose, cellulose acetate, regenerated cellulose, cellulose composites, polysulphone, polyethersulphone, polyarylsulphone, polyphenylsulphone, polyacrylonitrile, polyvinylidene fluoride (PVDF), and blends thereof. The membrane selected depends upon the application, desired filtration characteristics, particle type and size to be filtered and the flow desired.

The other filter components such as end caps, inlets, outlets, housings, spacers, retainers, manifolds, capsules, etc., to which a seal of the present invention may be applied, can be made of a variety of materials, such as metal, ceramic, glass or plastic. Preferably, the components are formed of metal such as stainless steel, especially 316 stainless steel or aluminum due to their relatively low cost and good chemical stability or more preferably plastics, such as polyolefins, especially polyethylene and polypropylene, homopolymers or copolymers, and ethylene vinyl acetate (EVA) copolymers; polycarbonates; styrenes;, PTFE resin; thermoplastic perfluorinated polymers such PFA; nylons and other polyamides; PET and blends of any of the above. When using a molded in place seal, it is preferred that the component to which the seal is bonded be compatible with and ensure a good adhesion between the components so that the seal remains as an integral part of the component to which it is bonded.

The seal is formed of any elastomeric material. The material does not need to be very elastic but it should have some ability to maintain the seal with the adjacent layers during flexion or compression. Preferably it has a durometer of from about 60 to about 100. Suitable materials include but are not limited to thermoplastics, such as polyethylene, polypropylene, EVA copolymers, alpha olefins and metallocene copolymers, PFA, MFA, polycarbonate, vinyl copolymers such as PVC, polyamides such as nylon, polyesters, acrylonitrile-butadienestyrene (ABS), polysulphone, polyethersulphone, polyarylsulphone, polyphenylsulphone, polyacrylonitrile, polyvinylidene fluoride (PVDF), and blends thereof, thermoplastic elastomers such Santoprene® polymer, EPOM rubber, thermosets such as closed cell foamed urethanes, and rubbers, either natural or synthetic.

It is preferred that the material be a thermoplastic or thermoplastic elastomer so as to allow for its use in the preferred method of this invention, injection molding. One such preferred material is a SANTOPRENE® polymer with a durometer of about 80 available from Advanced Elastomer Systems of Akron, Ohio. Preferred thermoplastics include low density, linear low density, medium density and high density polyethylene, polypropylene and EVA copolymers.

The seal is formed preferably by molding or bonding of seal to a portion or component of the device. Preferably, the seal is injection molded to the component. Thermoplastic elastomers and thermoplastics are preferred for the injection molding process although thermosets, such as rubber or urethane may be used. The gasket may be formed on one or both sides of the screen as desired. Preferably it is formed as one injection-molded piece on both sides of screen. To form such a gasket, two molds each corresponding to a half of the final gasket design are made and placed on opposite sides of feed screen in alignment with each other. Thermoplastic elastomers or molten thermoplastic or other selected seal material is then injected into either one or both mold pieces and fills the mold with the seal material, thus forming the desired gasket in place on the screen.

Altematively, if desired, the seal may be pre-molded and attached to the opening in the screen layer by various means such as adhesives or a mechanical retention of the seal such as by a press fit of the seal within the opening of the screen (similar to that of a rubber grommet).

A module according to the present invention is typically formed in the following manner: a screen, preferably a feed screen is formed with a series of ports in at least one, preferably both of its outermost edges opposite each other. Seals according to the present invention are formed and secured around the desired ports.

In a tangential flow filtration apparatus using the screen or module containing such screen of the present invention, the feed, retentate and filtrate ports are arranged so that the incoming fluid feed to the apparatus enters at least one feed channel, passes through the feed screen layer(s) and either passes through a membrane to form a filtrate stream or is retained by a membrane to form a retentate stream. The retentate stream is removed from the device through the one or more retentate ports and the filtrate stream is removed through the one or more filtrate ports. If desired, one or more filtrate inlet ports and one or more filtrate outlet ports can be formed so that some filtrate is recycled to the filtrate layer inlet port to effect tangential flow on the filtrate side. This may also be done on the retentate side instead of on the filtrate side or on both sides to increase tangential flow efficiency of the device. By doing so, one may control the transmembrane pressure within the device.

In a dead end flow filtration apparatus of the present invention, the feed and filtrate ports are sealed from each other and only filtrate is recovered from the module.

Other uses and embodiments for the invention will be obvious to one of ordinary skill in the art and it is meant to encompass these embodiments in the present invention and claims.

### EXAMPLE 1

A TFF module was made with a feed screen having an injection molded thermoplastic elastomeric gasket made from Santoprene® 80 durometer elastomer and 0.005 inch in height from each side of the screen. One layer of a composite regenerated cellulose membrane, PL composite, a relatively easily compressible membrane available from Millipore Corporation, was used in the module.

A comparison module, known as a PELLICON® Maxi cassette, available from Millipore Corporation of Bedford, Massachusetts was constructed similarly to the one above, except that the feed screen seal of standard epoxy was used. This seal was flush with the surface of the screen.

Both were tested in a PELLICON® SS benchtop manifold, available from Millipore Corporation of Bedford, Mass. at 350 inibs torque. Each was exposed to a series of 5 alternating cold/hot cycles using water as the fluid. The hot cycle was at a feed pressure of 60 psi and then a retentate pressure of 35 psi at 50° C. for two hours. The cold cycle was static storage in a refrigerator at 5° C. for 18 hours. Integrity of the seal in each cassette was tested at 10 psi intervals up to 110 psi between each cycle.

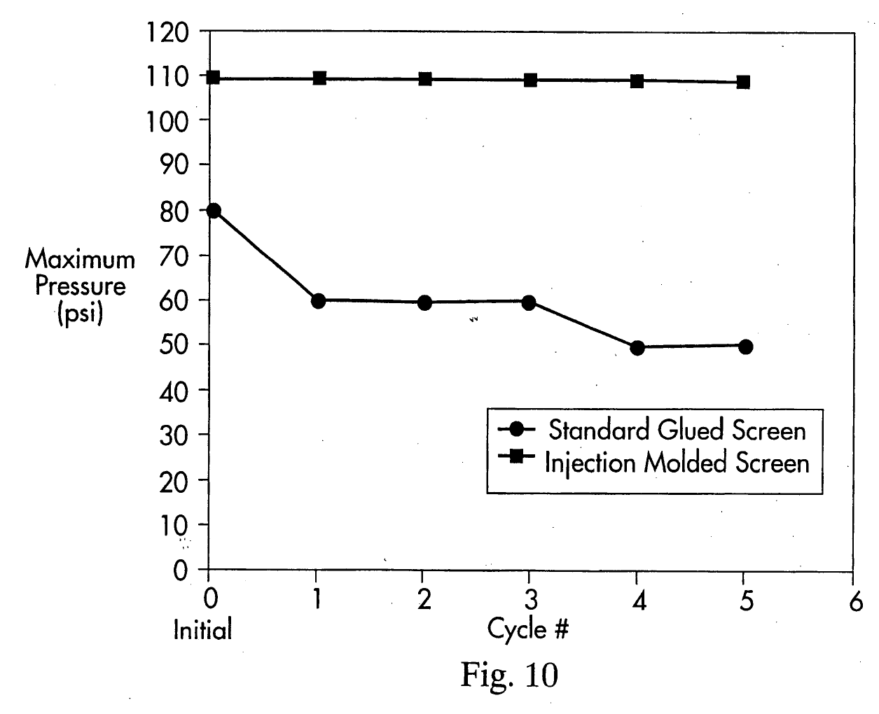

The integrity results were plotted in the graph of FIG. 10 for both devices. As can be clearly seen the molded gasket device maintained its integrity throughout the test. The traditional cassette failed to achieve the high initial pressure resistance of the module of the present invention (80 vs 110 psi) and it exhibited decreased sealing ability with increasing cycles.

The present invention has several advantages over the currently available devices.

First and foremost, it allows for the use of more compressible membranes than has been possible before, such as composite cellulose membranes. These membranes are highly efficient but due to their structure are easily compressible causing leakage to occur. The present invention overcomes the sealing problem created by such membranes thereby allowing for an entire new class of membranes to be used in filtration devices.

Second, it allows for the use of higher pressures in these applications, either with the traditional membranes or the newer more compressible membranes. Likewise, it is resilient in alternating hot/cold cycles which are quite common in filtration applications (cold for filtration, hot for inter batch cleaning). As the data clearly shows such therrnal cycling has no effect on the performance of the device utilizing the current invention.

Third, it allows for different port sealing geometries other than circular, and overall smaller diameter sealing areas than is possible with glued ports.

It allows for the use of thicker screens and/or more open screens or filter membranes as the there is no overfilling of the screens or membranes as occurs in gluing when using very open screens or membranes.

It can allow for the use of open volume spaces in lieu of a physical screen in a cassette format as it forms a rim/spacer between the adjacent layers that is traditionally filled with a screen.

It allows for the use of formed in placed gaskets, sealing devices and O-rings with controlled formation of the devices and little if any spreading of the material beyond the desired area. This is something that is not possible with epoxies and urethanes today.

It also allows for the sealing devices which have an ease of formation and application, low extractables, low absorption/desorption of components from the fluid being filtered.

When used in the preferred embodiment of formed in place seals, one obtains an integral seal on the device which has several advantages in the ease of assembly and use, the assurance that the seal is always retained at the right location and cannot be mis-aligned or mis-sealed. Additionally, in these molded in place embodiments, the seal eliminates any dead space between the seal and the filter component to which it is bonded in which a microorganism such as a bacteria, yeast, mold or virus could otherwise grow and threaten the integrity and sanitary condition of the filter.

The use of thermoplastics and thermoplastic elastomers offer increased cleanliness and lower levels of extractables than that found with the current urethanes, epoxies or silicones used in such devices.

1-26. (canceled)

27. A process for forming an integral seal around a port comprising the steps of:
providing a layer selected from the group consisting of a filter, a feed screen and a filtrate layer, the layer having one or more ports formed through it,
providing an elastomeric material,
molding the elastomeric material into an integral seal around at least one of the one or more ports in the layer such that the material forms a liquid tight seal around the at least one of the one or more ports.

28. The process of claim 27 wherein the elastomeric material is selected from the group consisting of thermoplastics, thermoplastic elastomers, thermoset elastomers and rubber, natural and synthetic.

29. The process of claim 27 wherein the elastomeric material is a thermoplastic elastomer.

30. The process of claim 27 wherein the elastomeric material is a rubber.

31. The process of claim 27 wherein the seal extends at least 0.001 inch above at least one side of the layer.

32. The process of claim 27 wherein the seal extends above both sides of the layer.

33. The process of claim 27 wherein the seal extends from about 0.001 to about 0.015 inch above at least one side of the layer.

34. The process of claim 27 wherein the seal extends from about 0.001 to about 0.015 inch above both sides of the layer.

35. The process of claim 27 wherein the seal is formed by injection molding.

36. The process of claim 27 wherein the height of the seal is also used to vary the channel height of the layer which is in the form of a feed screen.

37. The process of claim 27 wherein the height of the seal is also used to vary the channel height of the layer which is in the form of a filter.

38. The process of claim 27 wherein the height of the seal is also used to vary the channel height of the layer which is in the form of a filtrate layer.

39. The process of claim 27 wherein seal is in a form selected from the group consisting of a gasket, an O-ring and a sealing rim.

40. The process of claim 27 further comprising a sealing rim formed around at least a portion of the periphery of a surface of the layer.

41. A process for forming an integral seal around a port comprising the steps of:
providing a layer selected from the group consisting of a filter, a feed screen and a filtrate layer, the layer having one or more ports formed through it,
providing two molds each corresponding to a half of the seal design,
aligning the two molds on opposite sides of layer around at least one of the ports,
providing an elastomeric material to the two molds,
molding the elastomeric material into an integral seal around at least one of the one or more ports in the layer such that the material forms a liquid tight seal around the at least one of the one or more ports.

42. The process of claim 41 wherein the elastomeric material is injected into either one or both of the molds.

43. A process for forming an integral seal on a filter cartridge comprising the steps of:
providing a filter cartridge with one or more recesses formed thereon,
providing an elastomeric material and
applying the material to the one or more recesses so as to form an integral seal.

44. The process of claim 43 wherein the seal extends outwardly from the one or more recesses.

45. The process of claim 43 wherein the seal extends outwardly from the one or more recesses at least 0.001 inch.

46. The process of claim 43 wherein the seal extends outwardly from the one or more recesses from about 0.001 to about 0.015 inch.

47. The process of claim 43 wherein the seal is formed by injection molding.

48. The process of claim 43 wherein the seal is formed by injection molding using a mold around the one or more recesses.

49. A method of forming a filtration module comprising the steps of:
selecting one or more feed screen layers, one or more membrane layers, one or more filtrate layers, the one or more feed screen and filtrate layers having one or more openings formed therein,
molding a gasket around one or more of the openings of the feed screen, assembling the module by placing a feed screen, adding a membrane to at least one side of the feed screen and adding a filtrate layer over the membrane and compressing the layers together.
